(19) United States
(12) Patent Application Publication
(10) Pub. No.: US 2004/0150218 A1
(43) Pub. Date: Aug. 5, 2004

(54) Printer label carrier and method of use

(76) Inventor: Carl Wasko, Baltimore, MD (US)

Correspondence Address: LITMAN LAW OFFICES, LTD., P.O. BOX 15035 CRYSTAL CITY STATION, ARLINGTON, VA, 22215, US

(21) Appl. No.: 10/354,128

(22) Filed: Jan. 30, 2003

(51) Int. Cl. B42D 15/00

(52) U.S. Cl. 283/106

(57) ABSTRACT

A reusable printer label carrier is used to support an individual label for applying an imprint onto the label using a printer connected to a computer. p The carrier includes a main support panel having a release surface to support a label. Also, a method of removing a portion of a panel foldable over the main support panel to define a foldable flap which overlaps at least one edge of the label is provided. The carrier is fed into the printer, with the crease formed by the foldable flap forming the leading edge, the flap preventing the label from being inadvertently removed from the carrier by the printer feed mechanism. The main support panel is marked to indicate proper positioning of the label for repeatable printing of labels.

### BACKGROUND OF THE INVENTION

1. Field of the Invention

The present invention relates to a printer label carrier and a method of using a printer label carrier. In particular, the printer label carrier and method of use provide the capability of printing one label at a time on a reusable support using existing printers controlled by computers.

2. Description of the Related Art

The invention is directed to a printer label carrier and a method of using the carrier for applying imprints onto individual labels, i.e., printing the labels one-at-a-time using existing printers connected to computers, such as personal computers and laptops.

Two common types of printers are laser printers and inkjet printers. When a sheet of stationery is fed through a printer, the sheet passes through a mechanism inside the printer, often including at least one feed roller to move the sheet from the inlet (paper tray) past the imprint-applying device (toner roller or inkjets) to the outlet. When the sheet of stationery travels around the feed roller, one side of the sheet is slightly stretched as it travels around the roller, while the opposite side is slightly compressed. This slight difference in tension between the two sides of the sheet of stationery can cause multiple layer sheets (i.e., sheets having a plurality of layers) to separate slightly. Normally the degree of tension between the two sides of the sheet causes little, if any, serious consequences inside the mechanism. However, when any of the layers include an adhesive material, as is commonly found in labels, the edge of the slightly separated layer with the adhesive material exposed can protrude sufficiently outward to contact the roller or other surface surrounding the roller, and adhere to it. This can have major consequences, including jamming the printer mechanism.

Most printers connected to computers are controlled by software in the computers (drivers) to apply the imprint onto various types and sizes of paper. The most standard size of paper for printers used in the United States is 8 [symbol] inches by 11 inches, referred to as “standard” in the printer software. Labels commonly sold by manufacturers, such as Avery labels made by Avery Dennison Corp. of Pasadena, Calif., are adhesively backed and are provided on “standard”-sized sheets to enable them to be passed through the printer mechanism to receive the imprint, e.g., a name and address. The sheet holds from 2 to 30 labels per sheet (or more) arranged in rows and columns, the actual number of labels depending upon various factors including the size of the labels and any unused margins along the edges and between the rows and columns, etc. The sheet is also provided with a release surface, e.g., a coating, to permit the removal of the labels individually from the sheet to apply to another stationery item, such as an envelope. Thus, these label support sheets are multiple sheets in which the two layers include the release sheet and the labels themselves. These labels can potentially separate from the release sheet during their travel around feed rollers inside the printer mechanism, especially when the roller has a small diameter, causing the sheets to travel around a sharper curvature.

Often some of the labels are left unused on the support sheet. Refeeding used label support sheets often causes labels to separate as the support sheet travels around the printer rollers to the imprint-applying mechanism, because the labels lose some of their adhesive strength after passing through the printer the first time (caused in part by the heat generated inside the printer mechanism). As previously stated, the labels can then become caught in the printer mechanism when they separate, even by a small amount, and can adhere to an internal surface of the printer, thereby causing a jam. These kinds of jams involving materials adhesively caught inside the mechanism can cause permanent damage, or may be costly to repair.

Furthermore, some printers have a minimum practical size of stationery sheet (or envelope) which they can adequately feed through the mechanism without jamming due to sheet size. Thus, individual labels (assuming they were still adhered to a corresponding portion of release sheet) cannot be fed into these printers due to their exceeding the minimum size limitation of the printer.

Thus, there is a need to apply imprints onto individual labels while preventing the label from jamming in the printer. The present invention fulfills this need by providing a reusable label carrier and method of use of the carrier which can be used to apply an imprint onto a single label while preventing a printer jam caused either by label separation from its support, or by the label exceeding the minimum sheet size requirements of the printer. Preferably the label carrier has an overall size (when used to apply an imprint to a label) that corresponds to the standard size of a No. 10 business-type envelope that can be used essentially universally among existing printers.

Moreover, it is well known that computers connected to printers are provided with software for imprinting various types of stationery items, including envelopes. One type of software code, referred to as an “envelope menu” or an “envelope and label menu”, is provided as a pull-down menu or pop-up window in various word processing applications, such as Microsoft Word and WordPerfect. The specific software code referred to as “Envelopes” is considerably less complicated to set up and use than the code referred to as “Labels”. For imprinting envelopes, Microsoft Word, and other word processing programs are set up to use the standard No. 10 business envelope as the default envelope size, and the normal imprint location on the No. 10 envelope reflects the default settings in the programs for imprint location. Because the invention has the dimensions of a No. 10 envelope, it can take advantage of having the default settings in the word processing programs preset for its use. There is no need to change any of the software manufacturer's preset default settings when using the invention, which results in ease of use, simplicity, and time savings. Therefore, there is a need to imprint individual labels on the inventive carrier using the easier-to-use ‘Envelope’ menu and its default settings, rather than the more complicated ‘Labels’ menu. The present invention fulfills this need by providing a method of applying the imprint using the well known ‘Envelopes’ menu.

U.S. Pat. No. 4,944,827, issued to Lilly et al. on Jul. 31, 1990, teaches a label printing system, including a feature to separate the individual labels from the release sheet. U.S. Pat. No. 4,951,970, issued to Burt on Aug. 28, 1990, teaches a protective label form and carrier for use in printing individual label in a printer, the carrier including a transparent folded cover sheet.

U.S. Pat. No. 5,007,663, issued to Moran on Apr. 16, 1991, teaches a multiple ply label and carrier for applying individual labels to end use sheets such as envelopes. U.S. Pat. No. 5,083,979, issued to Burt on Jan. 28, 1992, teaches a protective label form and carrier. U.S. Pat. No. 5,833,274, issued to Schmidt on Nov. 10, 1998, teaches a method of using a label carrier, including a simultaneous printing and cutting step.

Although various label carriers and methods of preparing and using them are taught in the prior art, none of the references teach a reusable label carrier for printing individual labels and a method of preparing and using them as provided for herein.

None of the above inventions and patents, taken either singly or in combination, is seen to describe the instant invention as claimed. Thus a printer label carrier and method of use solvg the aforementioned problems is desired.

### SUMMARY OF THE INVENTION

The present invention is directed to a printer label carrier and a method of preparing and using the carrier. More particularly, the printer label carrier includes a removable panel for printing onto and aligning new labels, and a flap that is foldable onto a main support panel to hold a label in place while the carrier with the label are passed through a printer. The flap engages an edge of the label to prevent it from being caught in the printer mechanism during printing.

Accordingly, it is a principal object of the invention to provide a reusable printer label carrier to print individual labels for use on existing printers connected to and controlled by personal computers that prevents jamming of the printer mechanism due to label separation or to label size.

It is another object of the invention to provide a method of preparing and using the printer label carrier in order to prevent jamming of the printer mechanism due to label separation or to label size.

It is a further object of the invention to provide a printer label carrier which includes a pre-printable removable panel and a foldable flap to engage an edge of a label in order to hold it in place while the carrier supporting the label is passed through a printer mechanism.

It is yet another object of the invention to provide a method of using the above label carrier to apply imprints onto labels using the “envelope menu” feature of word processing applications.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a printer label carrier according to the present invention.

FIG. 2 is a perspective view of a printer label carrier having a portion removed.

FIGS. 3A, 3B, 3C and 3D show successive method steps for preparing the printer label carrier for use.

FIG. 4 shows a side view of the carrier with a label on the surface.

Similar reference characters denote corresponding features consistently throughout the attached drawings.

### DETAILED DESCRIPTION OF THE PREFERRED EMBODIMENTS

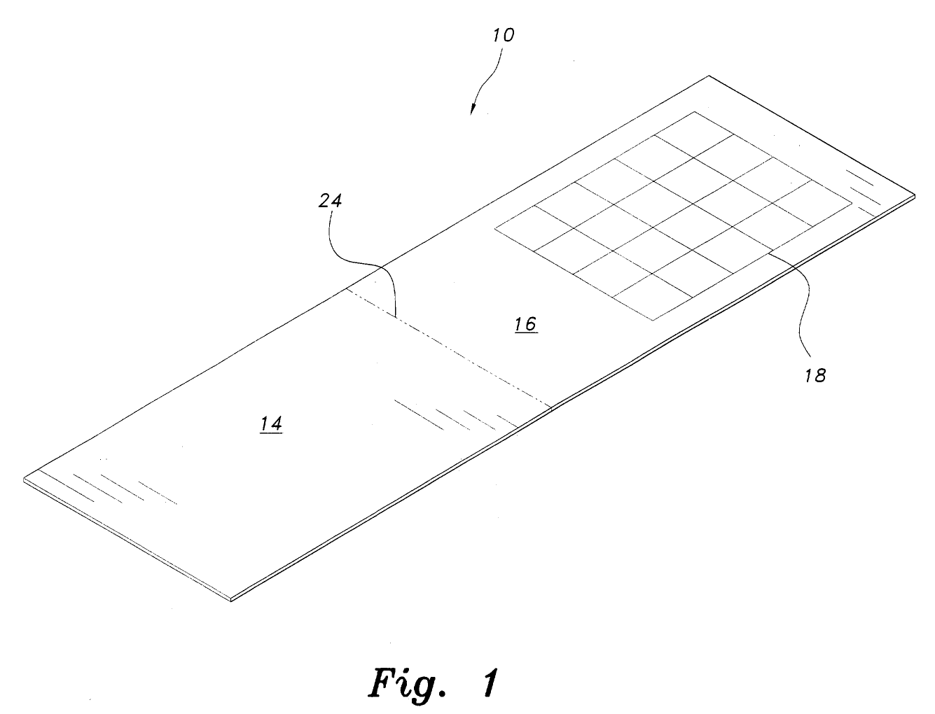

FIG. 1 shows a perspective view of the printer label carrier 10 of the present invention. Label carrier 10 includes a main support panel 16 which essentially provides a release layer for a label (not shown). Grid 18 is stamped onto the main support panel 16 and is provided to permit the user to place a label in the same alignment position during each use, thereby ensuring the imprint is applied onto the label at the same position for each label. The surface of the main support panel 16 has sufficient release characteristics to permit an adhesive label to be temporarily adhered to it during printing, yet also permit the label to be easily removed from the carrier after the imprint has been applied by the printer without loss of adhesive.

A foldable flap 14 is attached to the main support panel 16 at crease 24. Flap 14 is translucent or transparent and, after the flap 14 is folded onto main support panel 16, the surface of this flap 14 is capable of receiving an imprint during initial preparation of the carrier 10 in the manner discussed below.

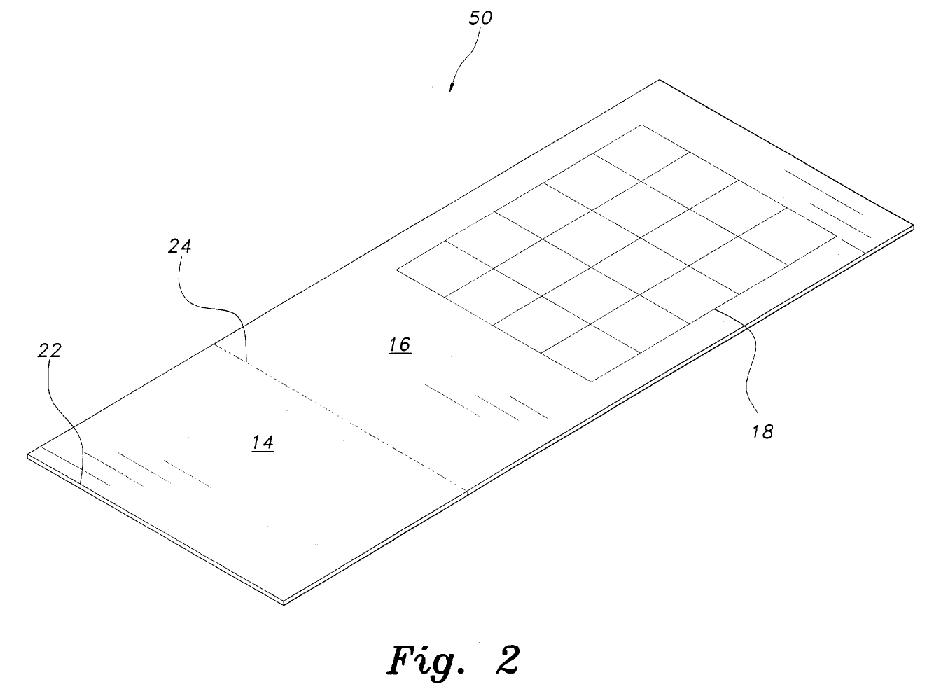

After initial preparation as discussed below, the resulting prepared label carrier 50 is shown in its unfolded state in FIG. 2 and is ready for use to apply imprints onto individual labels.

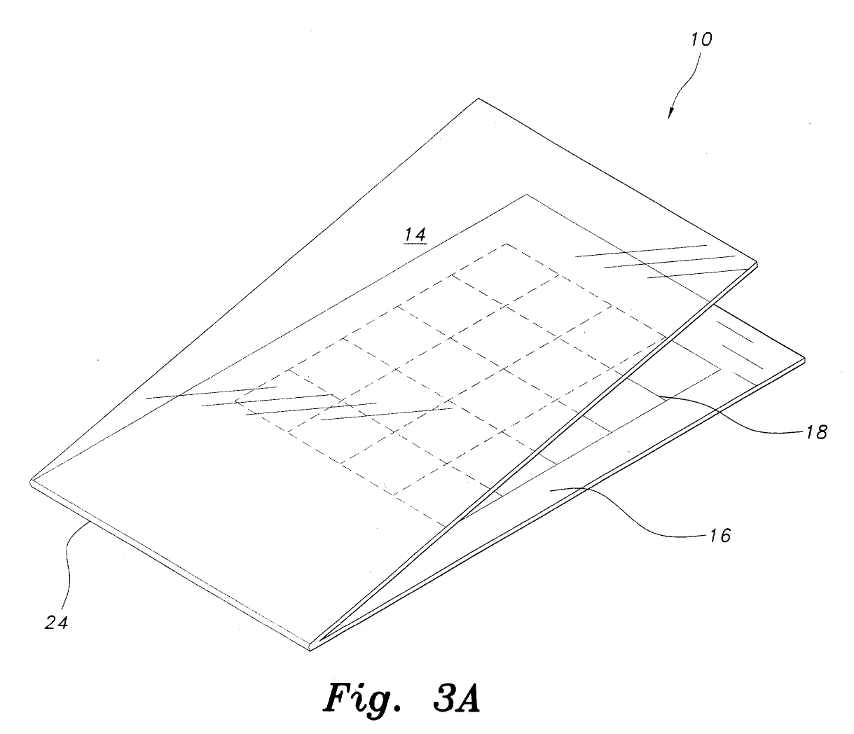

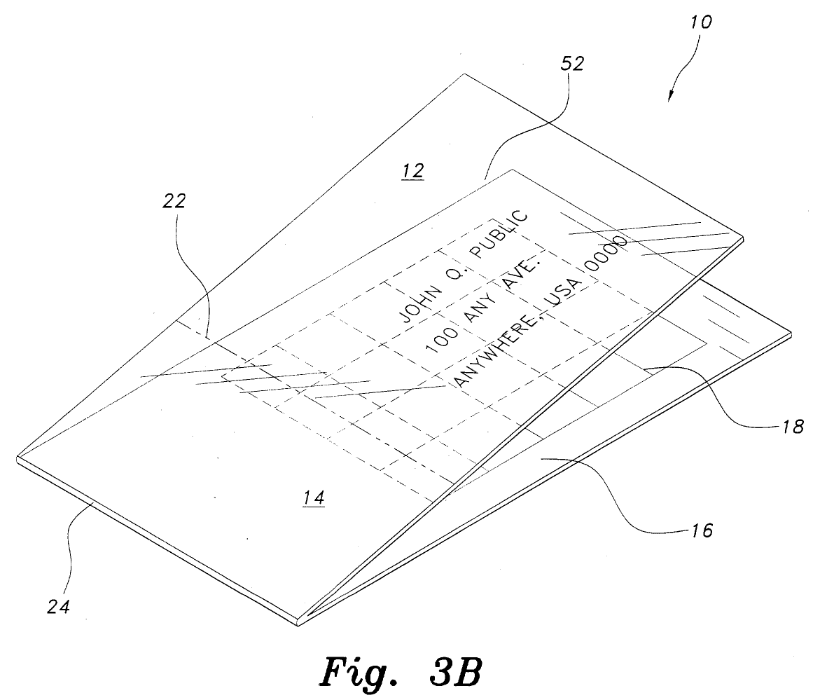

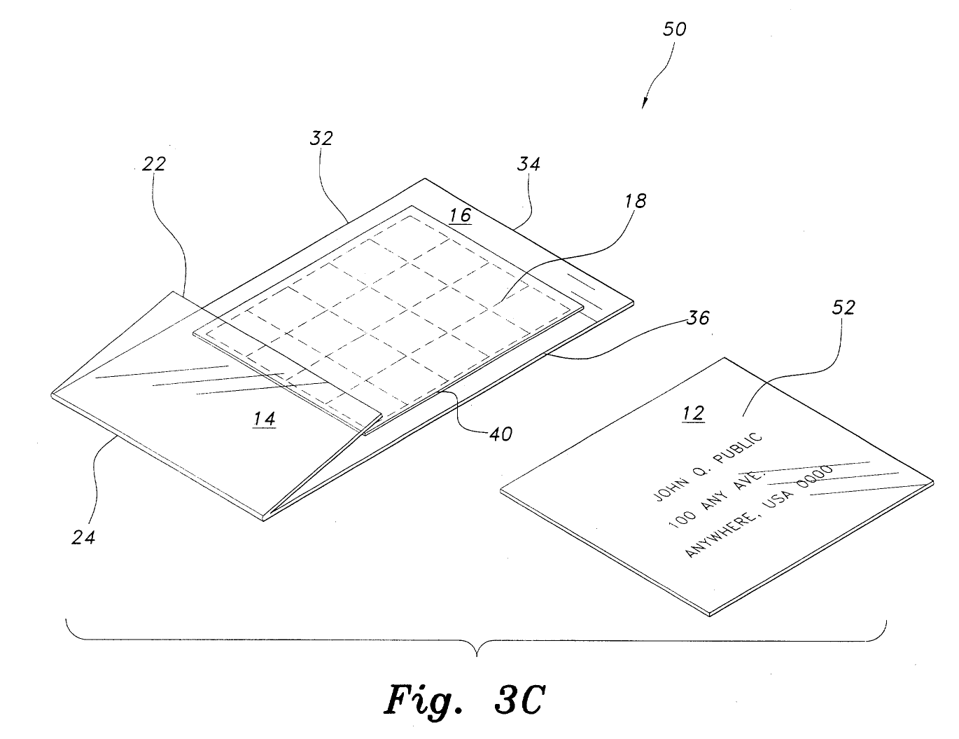

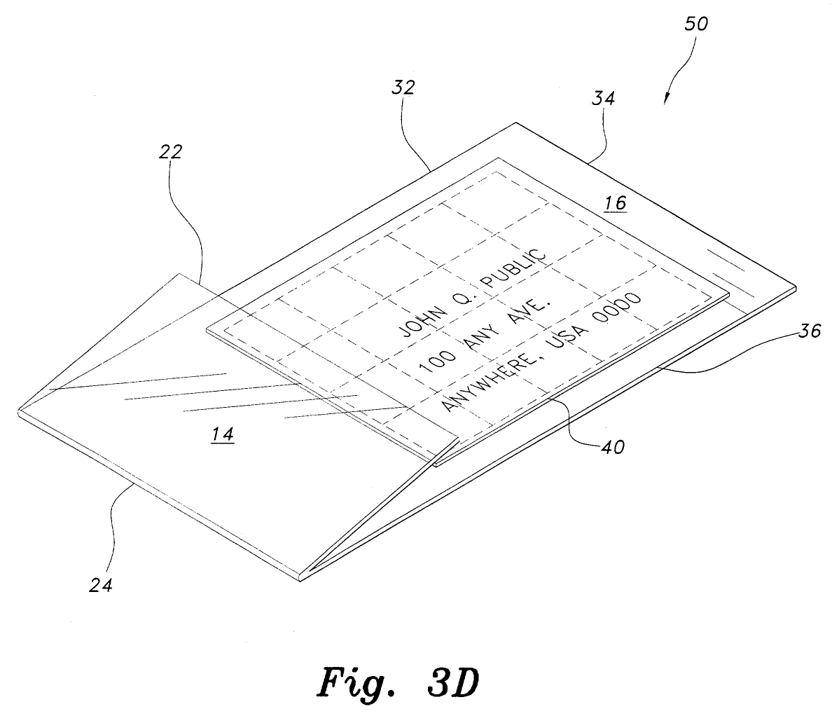

The steps for preparing the label carrier 10 for use are shown in FIGS. 3A-3D. In the first step of preparation of carrier 10, the carrier 10 is folded along crease 24 to superimpose flap 14 over main panel 16. Carrier 10 is then fed into a printer connected to a computer with crease 24 being used as the leading edge as the carrier 10 moves into the printer mechanism. The presence of the folded edge 24 is a key feature of the invention. It prevents the undesirable separation of the edge of the label from its support, thereby preventing jamming due to such separation. It is noted that any adequate overlap of the foldable flap onto the edge of the label is contemplated as long as the crease is in the direction of the feed into the printer mechanism.

The printer is set up to print a single label using software as is known in the art, in particular using the “envelope menu” feature generally provided in word processing applications. The resulting label imprint 52 is shown on the removable panel 12 in FIG. 3B. Alignment of the imprint is controlled by the printer software. In particular, in the word processing application, the individual types the desired address in a new document. Then the standard “envelope menu” is brought up, e.g., using a pull down menu or a pop-up window. In the “envelope menu” the #10 size envelope is the default selection. Printers have envelope feed port indicators, which indicate their default envelope feed orientation. Envelopes must be inserted either long side first or short side first. Although the crease is shown along the short edge of the carrier, as an alternative, the crease may be located along the long edge of the carrier (top or bottom of the carrier). Whichever default orientation is required by the printer, the carrier is inserted in such a way so that when the “Print” button is pressed, the crease goes into the printer first, as the leading edge.

The resulting printed carrier will receive the desired address imprint on flap 14 as shown in FIG. 3B. A blank label (not shown) is then placed underneath with adhesive side facing downward, so that the imprint receiving surface of the label is against the underside of flap 14. At this time, the label is positioned under the flap 14 to align the imprint receiving portion of the label with the imprint on flap 14 and, once aligned, the flap 14 and label are then both carefully brought into contact with support surface 16 until the adhesive surface of the label contacts surface 16 and is adhered thereto.

The next step involves marking the flap 14, using any suitable writing implement, such as a pen or pencil, with a line 22 across the flap 14 that corresponds to the position at which the flap 14 will be cut (using any suitable cutting implement such as scissors), while ensuring that the remaining portion of flap 14 adequately covers approximately 1/4 inch of the edge of the label closest to crease 24. This results in the two-piece structure shown in FIG. 3C. Removable panel 12 can then be discarded, leaving the label 40 uncovered for imprinting by the printer. With the label 40 in place on support 16, grid 18 can be marked to indicate the proper positioning of subsequent labels. The blank label 40 (and any subsequent labels) can then be printed by passing the carrier and aligned blank label adhered thereon through the printer, crease 24 first, resulting in the imprint being applied properly in alignment onto each blank label as shown in FIG. 3D. Imprinted labels can be removed from the carrier and placed onto other objects, such as parcels, large envelopes, etc.

Thus, once the carrier has been prepared as shown in FIG. 3C, each subsequent blank label is simply placed onto the support surface 16 with the edge of the label aligned with the previously applied alignment mark provided on grid 18, then flap 14 (without removed portion 12) is folded onto the edge of the label to cover approximately 1/4 inch of the edge, and the carrier/label assembly is then inserted into the printer, crease edge first.

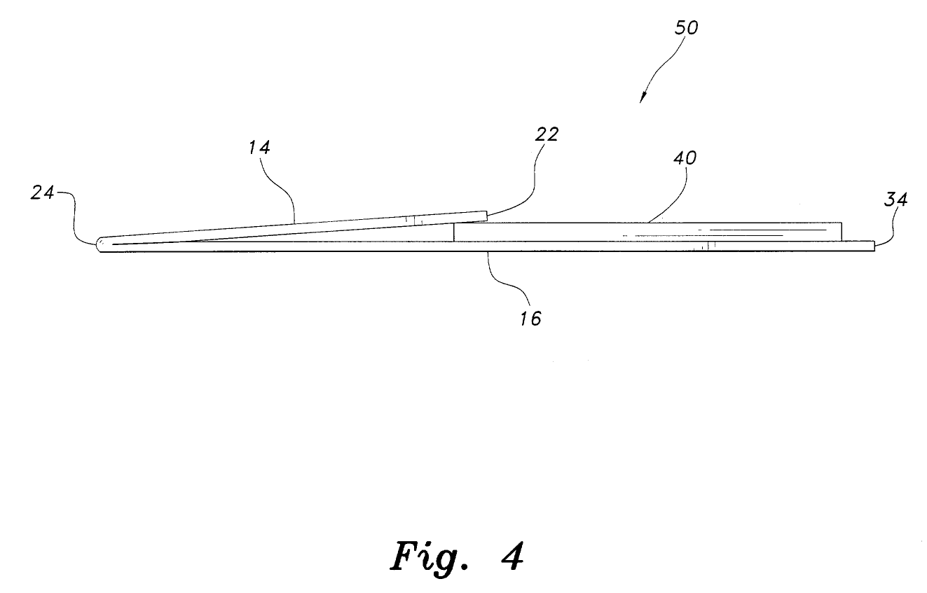

A side view of the resulting carrier with the label is shown in FIG. 4. The edge 22 of the flap 14 is shown overlapping an edge of the label 40. Although the amount of overlap is preferably 0 inch, any suitable overlap is contemplated that maximizes the available print area on the label 40, while also sufficiently ensuring that no label separation occurs during its passage through the printer mechanism.

Also, the size of the prepared carrier 50 as shown in FIG. 3D, i.e., the area, is preferably equivalent to the size of a standard No. 10 business-type envelope to ensure universal compatibility with existing printers and printer software. Thus, the length of the prepared carrier 50 (in reference to FIG. 4), from the crease 24 at the leading edge of the carrier to the trailing edge 34 is preferably 90 inches. Similarly the preferred width of prepared carrier between sides 32 and 36, is 4⅛ inches.

However, when the carrier is intended to be used in printers that have no minimum sheet size, as in some laser printers, the overall size of the carrier can be reduced considerably. The minimum size of the prepared carrier 50, including the main label support 16 and the flap 14, must at least be able to support the label as well as cover the leading edge of the label during use.

It is further noted that, although the crease 24 has been shown and described as being to the left of the imprinted address (i.e., FIGS. 3B and 3D), the crease can alternatively be provided along any of the remaining edges of the carrier with appropriate corresponding modifications being made to the original size and layout of the carrier. The sole requirement in all of these four possible orientations of the crease is that the edge of the label closest to the crease be covered by the remaining flap, preferably by approximately 1/4 inch, to ensure that the leading edge of the label does not become separated from the carrier as the assembly passes through the printer. In the orientation with the crease placed above the label, for example, the resulting prepared carrier can be used in printers which require the long edge of an envelope to be inserted first, as opposed to printers which require the short edge of an envelope to be inserted first.

Moreover, the blank labels can be provided with any suitable imprint, such as a return address, company logo, etc., so long as a satisfactory blank area is provided on the imprint side of the label for applying the desired delivery address.

In addition, rather than making a straight line cut across flap 14 as depicted and described, a rectangular or other opening can be made as well. Regardless of the shape of the cut, the resulting prepared carrier must nonetheless provide the necessary overlap of the entire leading edge of the label, i.e., the edge closest to the crease, while permitting the printer to apply the imprint to the proper imprint-receiving portion of the label.

Once the carrier has been prepared, the procedure to produce a new mailing label is as follows: open a new document in Microsoft Word, or Word Perfect, or virtually any other popular word processing program, type in the mailing address, got o the “Envelope” menu (where a copy of the mailing address will automatically be displayed), attach a label to the carrier at the proper location as shown on the grid, insert the carrier into the printer feed port with the crease as the leading edge, then click on the “Print” button. When the carrier, with label attached, emerges from the printer, detach the label from the carrier and attach it to the object to be mailed.

It is to be understood that the present invention is not limited to the embodiment described above, but encompasses any and all embodiments within the scope of the following claims.

I claim:

1. A printer label carrier capable of supporting a single printer label for applying an imprint thereon using a printer connected to a computer, the carrier comprising:
a main support panel adapted to support a single printer label, the support panel having four edges defining a generally rectangular shape, the edges including two opposed longitudinal edges, and two opposed lateral edges; and
a foldable panel attached to the main panel along one of the four edges defining a crease, the crease defining a leading edge of the carrier, the foldable panel having a printable surface;
wherein when a label is attached to the main support panel, and the foldable panel is folded onto the main support panel, an edge of the foldable panel overlaps a leading edge of the label.

2. The printer label carrier of claim 1, wherein the main panel includes a grid stamped thereon for aligning a label for registration of its position thereon.

3. The printer label carrier of claim 1, wherein the support surface of the main support panel comprises a release layer.

4. The printer label carrier of claim 1, wherein the carrier is made of a material selected from the group consisting of plastic, paper, and coated paper.

5. A method of preparing the printer label carrier of claim 1 for applying an imprint onto a label, comprising the steps of:
folding the carrier along the crease to superimpose the foldable panel onto the main support panel;
feeding the folded carrier into a printer, the crease defining the leading edge of the carrier as it passes through the printer, thereby applying an imprint onto the foldable panel;
retrieving the folded carrier with the applied imprint;
applying an adhesive label to the main support panel so that the label is disposed beneath the foldable panel;
marking a portion of the foldable panel for removal in order to define a removable panel, the remaining portion of the foldable panel extending over at least one quarter of an inch of the label nearest the crease;
marking the label [symbol] s position on the main support panel;
removing the label; and
removing the removable panel.
